(19) United States
(12) Patent Application Publication
(10) Pub. No.: US 2011/0228098 A1
(43) Pub. Date: Sep. 22, 2011

(54) AUTOMATIC MOTION TRACKING, EVENT DETECTION AND VIDEO IMAGE CAPTURE AND TAGGING

(76) Inventors: Brian Lamb, Belmont, CA (US); Vladimir Tetelbaum, Redwood City, CA (US)

(21) Appl. No.: 13/025,114

(22) Filed: Feb. 10, 2011

Related U.S. Application Data
(60) Provisional application No. 61/337,843, filed on Feb. 10, 2010.
(60) Provisional application No. 61/343,421, filed on Apr. 29, 2010.
(60) Provisional application No. 61/402,521, filed on Aug. 31, 2010.

(51) Int. Cl. H04N 5/33; H04N 5/225

(52) U.S. Cl. 348/164; 348/169; 348/E05.09; 348/E05.024

(57) ABSTRACT

A method is provided to track an object, the method comprising: directing a video imager to perform image recognition to recognize a feature of the object within an imager field of view and to determine a position of the feature within the field of view; using an IR sensor to determine a position of an infrared (IR) transmitter; and automatically adjusting orientation of the imager as a function of the position of the recognized feature within the field of view and the determined position of the IR transmitter to follow movement of the object.

### CROSS-REFERENCE TO RELATED APPLICATIONS

This application claims priority to commonly owned co-pending provisional patent application Ser. No. 61/337,843 filed Feb. 10, 2010, and to commonly owned co-pending provisional patent application Ser. No. 61/343,421 filed Apr. 29, 2010, and to commonly owned co-pending provisional patent application Ser. No. 61/402,521 filed Aug. 31, 2010, which are expressly incorporated herein by this reference in their entirety.

### BACKGROUND

Capturing video images of an object that moves from one location to another requires changing the orientation of the video imager as the object changes locations. While this is not difficult to accomplish when a person manually changes the imager orientation, it is not such a simple task when automated tracking is required. Moreover, manually tagging a video data stream after the video has been captured to indicate the location in the video of the depiction of events is well known. However, automated tagging of a video stream in real time to indicate the location of video corresponding to events is not such a simple task. There has been a need for improvement in the automatic tracking of objects to be captured on video as the object move about from one place to another. In addition, there has been a need for automatic real-time tagging of video streams with event information.

### BRIEF DESCRIPTION OF THE DRAWINGS

FIG. 1 is an illustrative generalized block diagram of a system that includes a remote device and a base device in accordance with some embodiments.

FIG. 2 is an illustrative drawing representing control architecture of the remote device in accordance with some embodiments.

FIG. 3 is an illustrative drawing representing control architecture of the base device in accordance with some embodiments.

FIG. 4 is an illustrative block diagram representing generation and transmission and the collection and processing of sensing data in the course of capturing a video image of an object to determine an estimated position of the object and to use the estimated position to cause an imager to track the object as it moves.

FIG. 5 is an illustrative drawing showing details of a quad cell IR photocell sensor 118 in accordance with some embodiments.

FIGS. 6A-6B are illustrative drawings of two example fields of view of the imager.

FIG. 7 is an illustrative flow diagram showing details of a sensor fusion process to determine remote device position in accordance with some embodiments.

FIG. 8 is an illustrative flow diagram representing a process in which the base device receives sensor data from the remote device and stores the received sensor data in memory device in accordance with some embodiments.

FIG. 9 is an illustrative flow diagram representing a process to detect an event based upon received sensor information in accordance with some embodiments.

FIG. 10 is an illustrative flow diagram representing a process to detect an event based upon received user UI input information in accordance with some embodiments.

FIG. 11 is an illustrative flow diagram representing a process to evaluate validity of a remote device position determined according to the sensor fusion process of FIG. 7 in accordance with some embodiments.

FIG. 12 is an illustrative flow diagram representing a process to determine distance between the remote device and the base device based upon audio data in accordance with some embodiments.

FIG. 13 is an illustrative drawing of a merged data structure encoded in the storage device of the base device in accordance with some embodiments.

FIG. 14 is an illustrative drawing of a circuit for IR signal improvement in accordance with some embodiments.

### DESCRIPTION OF THE EMBODIMENTS

The following description is presented to enable any person skilled in the art to make and use a system, method and article of manufacture to track the position of a target object, to detect the occurrence of events associated with the tracked object and to create a video record of the tracked object that is associated with indicia of the detected events and indicia of portions of the video record that correspond to the detected events. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Where the same item is shown in different drawings that item is marked with the same reference numeral in each drawing in which it appears. Thus, the present invention is not intended to be limited to the embodiments shown, but is to be accorded the widest scope consistent with the principles and features disclosed herein.

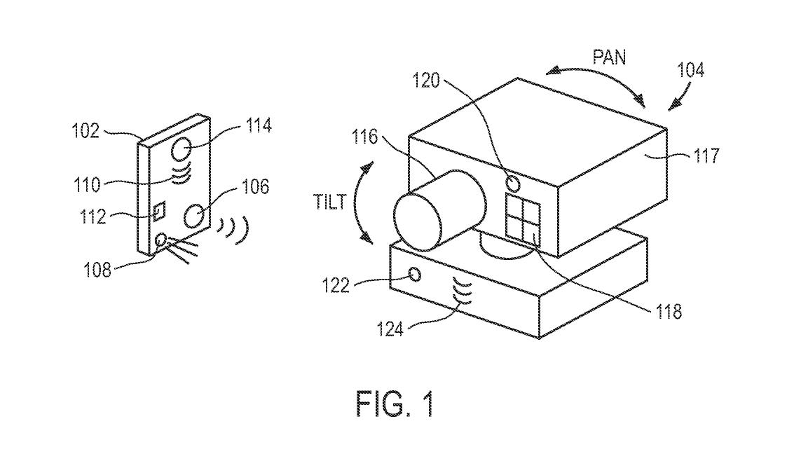

FIG. 1 is an illustrative generalized block diagram of a system 100 that includes a remote device 102 and a base device 104 in accordance with some embodiments. The remote device 102 can be disposed upon an object (not shown) such as a person that is to be tracked and imaged (the ‘tracked object’). The remote device 102 includes communication components such as multiple infrared (IR) transmitters 106 (only one shown) disposed at different locations on the surface of the remote device to indicate the location of the remote device. IR signals produced by the IR transmitters 106 acts as beacons to indicate remote device location; the remote device sometimes is referred to as a ‘beacon’. In some embodiments, multiple IR transmitters are disposed at different locations on the remote device to increase the likelihood that at least one IR transmitter will have line of sight communication with the base device 104 regardless of remote device orientation. The remote device 102 also includes a radio frequency (RF) transceiver 108 used to communicate data with the base device 104. In some circumstances, the IR transmitter 106 also can be used to transmit data. In addition, the remote device 102 includes sensors such as a microphone 110 to sense sound and an accelerometer 112 to sense motion. The remote device 102 also includes a user interface (UI) actuator 114, such as one or more control buttons, to receive user input commands or information. The base device 104 mounts an imager 116 to capture images of a tracked object (not shown) on which the remote device 102 is disposed. A servo system 117 changes the orientation of the imager 116 so as to track motion of the tracked object by causing tilt and pan movements of the imager in response to detection of changes in tracked object position. The base device also includes communication components such as an IR receiver 118, an IR transmitter 120 and an RF transceiver 122 to communicate with the remote device 102. The IR transmitter 120 is disposed relative to the IR receiver 118 such that when the imager 116 moves both the IR receiver 118 and the IR transmitter 120 move with it together. The reason for this arrangement is so that the IR receiveer 118 and the IR transmitter 120 remain aligned with each other so that an IR signal transmitted by the IR transmitter 120 and reflected off the target will be more readily sensed by the IR receiver 118. In some embodiments, the IR transmitter 118 and the IR receiver 120 are disposed on the same surface of the base device and are disposed adjacent to each other on that surface. The IR receiver 118 detects IR signals transmitted by remote device IR transmitters 106. The base device IR 120 transmitter transmits IR signals to be reflected off the tracked object and sensed by the IR receiver 118. In some embodiments, the IR receiver 118 and the base device IR transmitter 120 are disposed adjacent to the imager 116 closely enough spaced so that the servo system 117 changes their orientations so that they also track changes in orientation of the imager 116; the result is that the IR receiver 118 and the base station IR transmitter 120 continue to be oriented for IR communication with the remote device 102 despite changes in tracked object position. The base device RF transceiver 122 is used to communicate data with the remote device RF transceiver 108. As mentioned above, the IR receiver 118 also can be used to receive data transmitted by the remote device IR transmitters 106. The base device 104 also includes a microphone sensor 124 to detect audio associated with a tracked object upon which the remote device 102 is mounted.

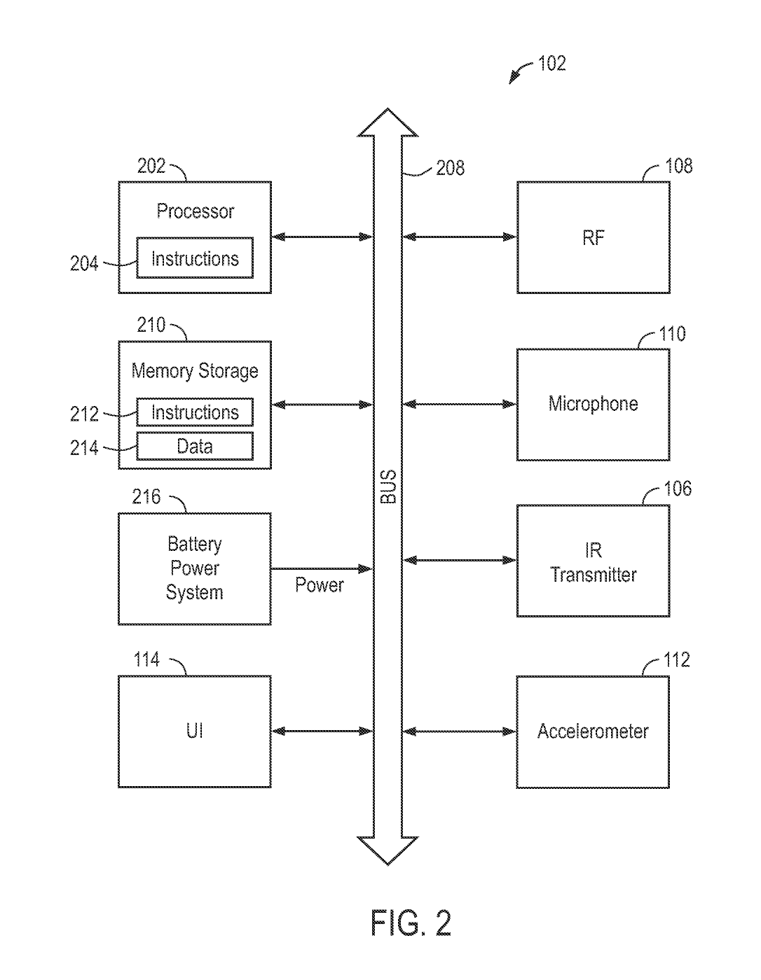

FIG. 2 is an illustrative drawing representing control architecture of the remote device 102 in accordance with some embodiments. The remote device 102 includes a processor 202 that can be configured according to instructions 204 to control performance of various tracking, event detection and recording acts described herein. The processor 202 is operatively coupled through a communication bus 208 with a machine readable storage device 210 that stores instructions 212 for use to configure the processor 202 and that stores data 214 to be processed by the configured processor. The bus 208 also operatively couples the processor 202 with other components described herein. The storage device 210 may include FLASH, EPROM, EEPROM, SRAM, DRAM or Disk storage, for example. The remote device 102 includes a battery power system 216. The plurality of Infrared (IR) Light Emitting Diodes (LED's) 106 (only one shown) provide an IR beacon for use by base device IR sensors 118 to detect and track the remote device and the target object that it is disposed upon. Accelerometer sensor 112 detect motion of the remote device. The RF transceiver 108 allows for RF communication with the base device 104. The microphone 110 detects sounds associated with the remote device or the target object on which the remote device is disposed. User interface components 114 such as buttons or switches permit users to manually control the operation of the remote device and to generate RF communication signals to the base device 104.

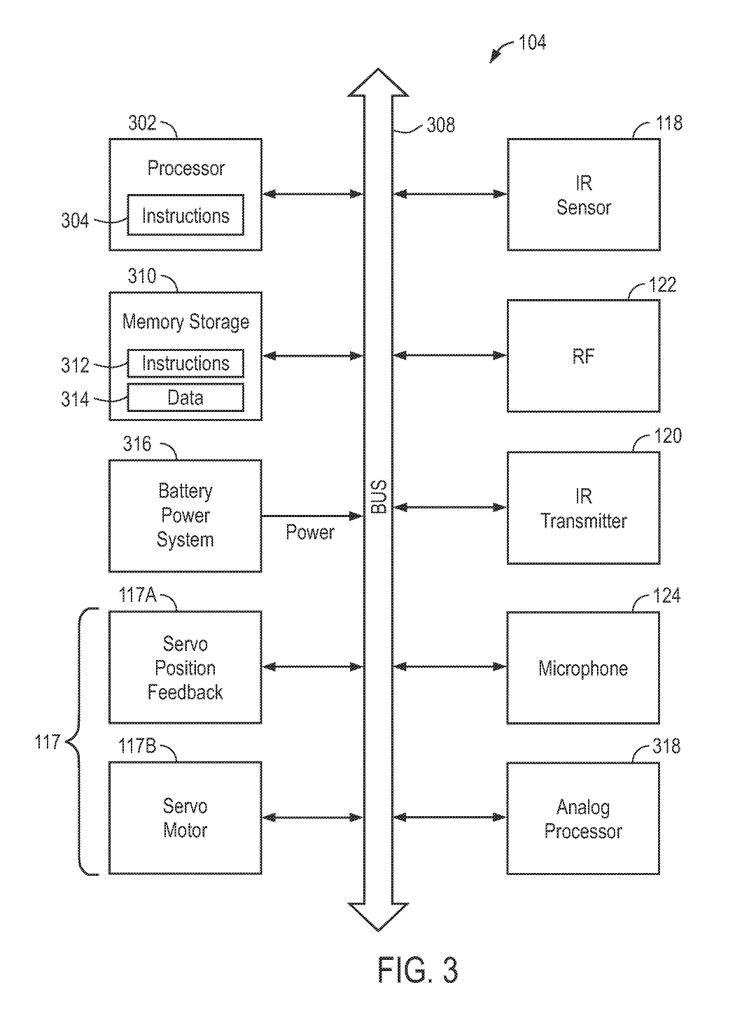

FIG. 3 is an illustrative drawing representing control architecture of the base device 104 in accordance with some embodiments. The base device 104 includes a processor 302 that can be configured according to instructions 304 to control performance of various tracking, event detection and recording acts described herein. The processor 302 is operatively coupled through a communication bus 308 with a machine readable storage device 310 that stores instructions 312 for use to configure the processor 302 and that stores data 314 to be processed by the configured processor. The bus 308 also operatively couples the processor 302 with other components described herein. The storage device 310 may include FLASH, EPROM, EEPROM, SRAM, DRAM or Disk storage, for example. The base device 104 includes a battery power system 316. The IR sensor 118 detects IR signals. In some embodiments, the IR sensor comprises a 4x quadrant IR photocell. The RF transceiver 122 permits RF communication. The IR transmitter 120 produces IR signals to aid in tracking the tracked object through reflection off the tracked object and detection by IR sensor system. The microphone 124 detects sounds. The servo system 117 comprises a servo position feedback system 117A that includes an imager position sensor (not shown) that detects the instantaneous servo system position that indicates changes in position of the imager 116. The imager position sensor may comprise optical encoders or variable resistors that produce imager tracking data that indicate the position and changes of position of a tracked object within an imager field of view. For example, in a dual axis system (pan and tilt) servo position sensors report the position of each controlling servo relative to a default. The servo system includes a servo motor that imparts both panning motion and tilt motion to adjust the orientation of the imager 116 so that it follows the tracked object. An analog processor 318 is provided to perform analog computation based upon IR sensor information. It will be appreciated that in alternative embodiments, an ASIC device may be used to perform functions of the processor 318.

Referring again to FIG. 1, the imager 116 comprises a portable imaging system (PIS) such as a video camera, mobile phone, gaming device or music player that can be mounted on the base device servo system 117. The imager includes an imaging sensor (e.g., CMOS or CCD style). An imager processing system, (not shown) is configured to evaluate captured and stored video in real time and to perform one or more of the following functions: to recognize pre-specified patterns (e.g., face detection, object detection, human shape detection, color detection). Video content recorded by the imager 116 is periodically time stamped to provide a time-based index into different portion of the video stream.

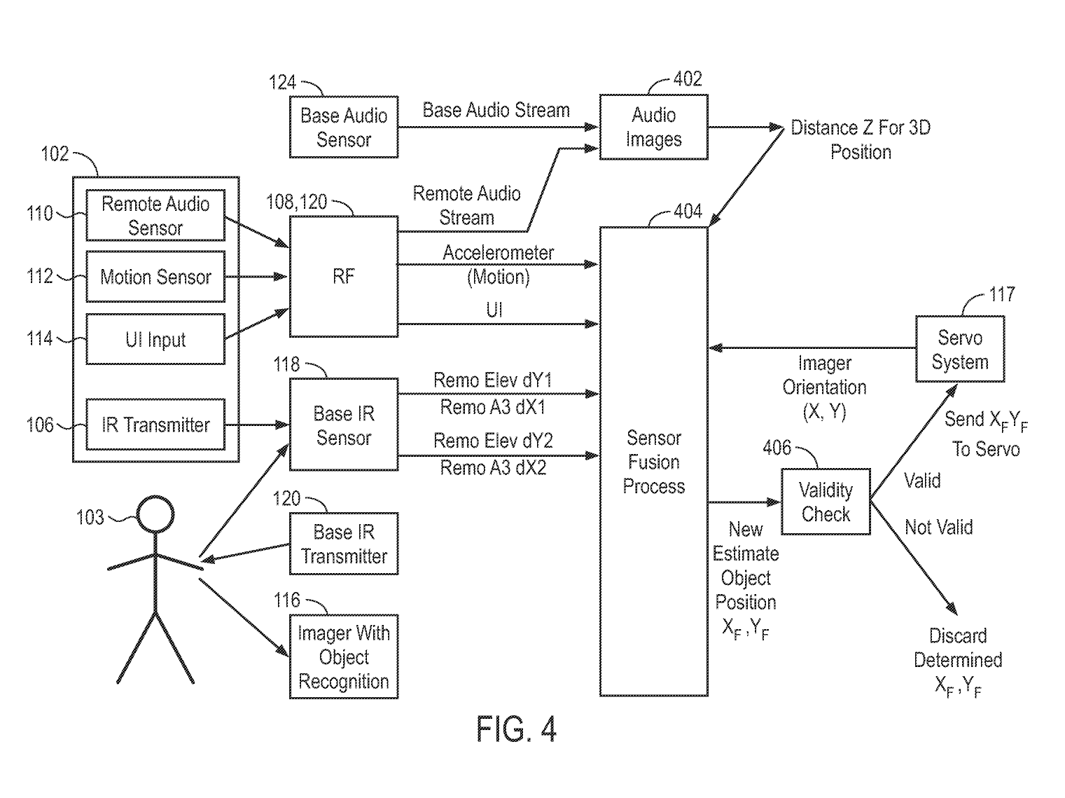

FIG. 4 is an illustrative block diagram representing generation and transmission and the collection and processing of sensing data in the course of capturing a video image of an object to determine an estimated position of the object and to use the estimated position to cause an imager to track the object as it moves. In this illustrative example, the remote device 102 is disposed upon a person who serves as the tracked object 103. The servo system 117 causes the imager 116 to follow movements of the tracked object based upon the sensing data.

The remote device 102 microphone 110 acts as an audio sensor to sense sound information imparted to the remote device 102. For example, the sound may be produced when a baseball bat hits a baseball or when a person speaks. Moreover, the base device microphone 124 also acts as an audio sensor to sense sound information. As explained below with reference to audio analysis block 402, a difference in the arrival time of sound at the remote device 102 and the arrival time of the same sound at the base device 104 provides a measure of distance between the two devices. In alternate embodiments, audio analysis block 402 can be part of the imager system 116.

The remote device accelerometer 112 acts as a motion sensor to detect motion imparted to the remote device 102. The accelerometer detects motion of the remote device 102. When the remote device is disposed upon an object 103 (e.g. a person's head, arm, torso, etc), the motion of the remote device 102 indicates motion of that object. In some embodiments, the accelerometer outputs multi-dimensional acceleration data that is filtered (e.g. noise removal filters) and integrated to produce tracking data that is indicative of a change of position since last measurement using algorithms known in the art (e.g., dead reckoning). In some embodiments a three axis accelerometer is used that provides an acceleration motion value for each of the three dimensions. The remote device 102 transmits motion data generated by the accelerometer 112 over the RF communication channel to the base 104 where computation of position based upon the motion data occurs. Moreover in alternative embodiments, the accelerometer may be employed as part of a more robust inertial navigation system (INS) that uses computer processing, linear motion sensors (accelerometers) and rotation motion sensors (gyroscopes) to continuously calculate the position, orientation, and velocity (direction and speed of movement) of the tracked object without the need for external references. Gyroscopes measure the angular velocity of the object in an inertial reference frame. By using the original orientation of the system in an inertial reference frame as the initial condition and integrating the angular velocity, the current orientation of the tracked object can be determined at all times.

User input is received via the user interface (UI) 114.

Audio sensor information, and motion sensor information and the UI input information are communicated to the base device 104 through RF transmission. During initialization, when the remote device 102 and the base device 104 first begin a communication session, an RF communication channel is established between the remote device 102 and the base device 104. Establishing the RF channel involves synchronization of communications signals between the devices. In some embodiments, the synchronization involves establishing a unique time basis, such as an agreement between the remote device and the base device on specific time slots for prescribed categories dedicated communication between them to take place. Alternatively, for example, the synchronization involves setting unique RF frequencies for communication.

The remote IR transmitter 106 produces an IR signal to act as a beacon to indicate the remote device position. The IR signal produced by the remote IR transmitter 106, which is a first IR signal, proceeds in a first direction that follows a path. In the example illustrated in FIG. 4, the path of the first direction is represented by the arrow from IR transmitter 106 to IR sensor 118. It will be appreciated, however, that if the IR transmitter 106 is oriented so that the first direction in which it transmits IR signals does not intersect the base device IR sensor 118, then that IR sensor 118 will not receive the IR signal transmitted by the IR transmitter 106 in the first direction. The IR transmitters 106 associated with the remote device 102 emit periodic IR signals that have short pulse duration and a low duty cycle (e.g., 1%) in order to save battery life. The IR signals have a wavelength that is not visible to the imager 116, and therefore, do not interfere with the capture of visual images by the imager. Moreover, in some embodiments, the IR signal pulses have characteristics such as signal shape and short duration pulse that act to differentiate it from ambient IR signals (e.g., the sun). In some embodiments, signal pulse shape is defined by amplitude versus time. For example, pulse shape can be a triangular shape, a ramp up of amplitude over time followed by a ramp down. Alternatively, pulse shape can be rectangular, a step from no signal to full signal for a short period of time followed by no signal again. In some embodiments, the remote device IR signals are transmitted according to a selected time basis (e.g., IR signal pulses are transmitted during prescribed time slots) agreed upon with the base station over the RF channel.

The base device IR transmitter 120 emits IR signals similar to those emitted by the remote device IR transmitters 106 but at a different unique time basis (e.g., during a different time slot). The base device IR signal, which is a second IR signal, proceeds in a second direction toward the tracked object 103. The second direction is represented by the arrow from the base IR transmitter 120 to the tracked object 103. The base device IR signal reflects off the tracked object 103 in a third direction represented by the arrow from the tracked object to the base device IR sensor 118, and the base device IR sensor 118 detects the reflected IR signal. The base IR transmitter is aligned to point in the same direction as the quad cell sensor. The reflection from the tracked subject is expected to come directly back into the quad cell sensor. The base device IR signals also can act as a backup to the remote IR signals. For example, the base device IR signals provide for more robust tracking through detection of reflected base device IR signals from the tracked object 103 that continue to track the object even when the remote device IR signals become temporarily blocked or out of line of sight.

Additionally, data may be transmitted over the remote device IR channel as a backup or supplement to the RF communications channel such as the remote device's unique identifier, accelerometer and other sensor information, such as UI control buttons actuated by a user.

The imager 116 implements one or more object recognition algorithms. Once an object to be tracked has been identified within a field of view of the imager 116, the imager follows the object within the imager field of view using known image recognition techniques. In some embodiments, video captured by the imager is evaluated frame by frame to track object movement. For example, in some embodiments, a known face detection algorithm is used to recognize a face within a video image and to track movement of the face within the imager field of view. An initial position of the tracked object is obtained by the imager 116 at the start of a tracking operation based upon IR signals detected by the IR sensor 118. Alternatively, a user initially may point the imager 116 at the tracked object at the start of the tracking operation. Subsequently, the imaging system employs object recognition techniques to independently track the object within the imager field of view based upon the object recognition algorithms.

A sensor fusion process 404 determines position of the tracked object 103 as it moves. The base device servo system 117 adjusts the orientation of the imager 116 to position it continue to track object 103 as it changes position. In some embodiments, the fusion algorithm employs a Kalman filter process to track target object position. A Kalman filter process produces estimates of the true values of measurements and their associated calculated values by predicting a value, estimating the uncertainty of the predicted value, and computing a weighted average of the predicted value and the measured value. In general, in a Kalman filter process, the most weight is given to the value with the least uncertainty. Thus, the sensor fusion process 404 receives as input potentially noisy input data from multiple sensors (e.g., accelerometer, audio, IR, UI and imager) and fuses the data to determine an estimate of the instantaneous position of the tracked object 103. It will be appreciated that the noise is generated by uncertainty of measurement and not by inherent sensor signal noise. The sensor fusion process 404 runs periodically to update a determined position of the tracked object 103 at prescribed time increments. In some embodiments, the time increments correspond to time intervals in which a time stamp is (or may be) associated with captured video images so as to more easily tag the captured video with target object positions that are associated with time stamps to indicate the portions of the video that corresponds to the computed positions. The position information computed by the fusion process 404 is stored in the storage device 310 for use by the servo control system 117 for tracking, for validity checks and history, for example.

Validity process 406 checks the validity of a target object position computed according to the fusion process 404. In some embodiments, a set of rules for target position data are built in a table to assess tracking validity. If a determined position does not satisfy one of the rules, then the determined position is invalid and is discarded. If a determined position satisfies the one or more validity rules then the determined position is valid and the determined position is passed to the servo 117 and is stored together with a time stamp to indicate it's time of occurrence relative to portions of the video image stream.

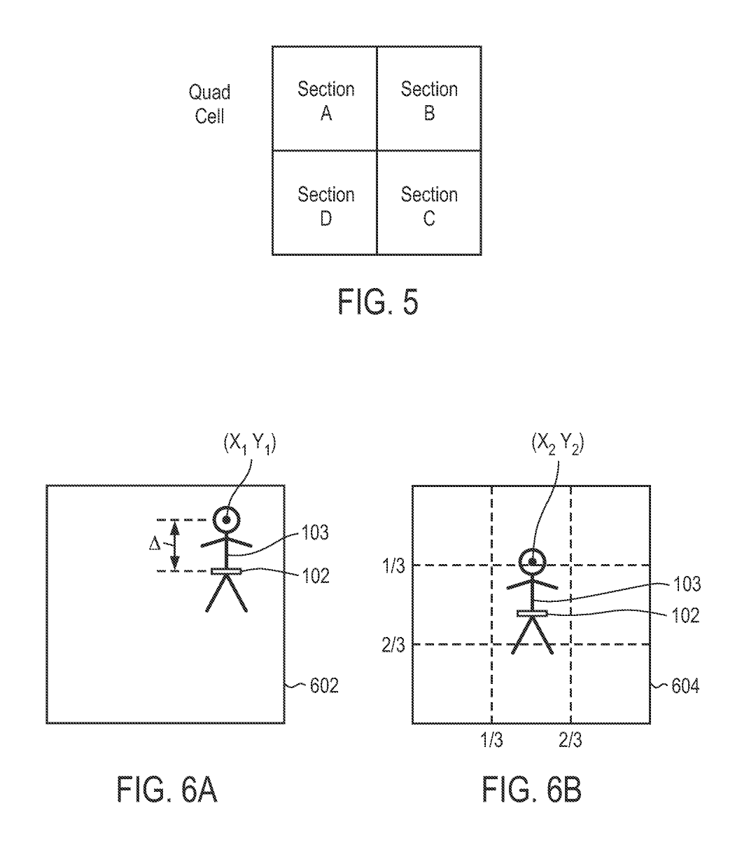

FIG. 5 is an illustrative drawing showing details of a quad cell IR photocell sensor 118 in accordance with some embodiments. The IR sensor includes four quadrants labeled A, B, C, D each including a photosensor section. The quad cell IR sensor computes values indicative of azimuth, elevation, and magnitude of the IR device signals and the reflected IR signals. Azimuth represents the offset between the orientation of the imager 116 and the tracked object 103 in the horizontal axis. Elevation represents the offset between the imager 116 and the tracked object 103 in the vertical axis. Magnitude represents the overall strength of the received IR signal. More particularly, the quad cell IR sensor provides information on how much IR energy is detected in each of the four cells and calculates the tracked object's position relative to that cell.

Varying states of the magnitude of the IR signal (either generated by the remote device 102 or reflected from the tracked object) represent digital data in the form of zeros (no IR light) or ones (IR light present). The magnitude of the IR signal is the sum of four cells:

Mag=A+B+C+D.

The horizontal target position (or azimuth) is defined by the difference of the horizontally aligned cells:

Az=((B+C)−(A+D))/Mag

The vertical target position (or elevation) is defined by the difference of the vertically aligned cells:

El=((A+B)−(C+D))/Mag

In some embodiments, distance information as well as received magnitude of the IR signal (in the base device) is used to communicate back to the remote device the amount of gain to use for IR LEDs. The base device measures IR signal strength using Magnitude value from the quad cell IR sensor. If the Magnitude signal is greater or smaller than the specified parameters (pre-programmed in the base device) then the base instructs the remote device via RF communications to decrease or increase the gain of the IR signal.

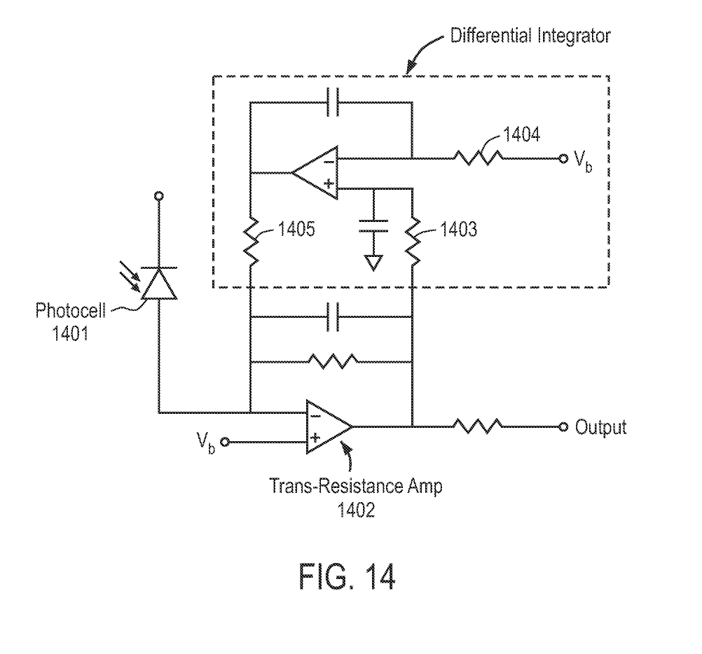

FIG. 14 is an illustrative drawing of a circuit for IR signal improvement in accordance with some embodiments. A high level of IR background radiation present in outdoor locations can cause saturation of transresistance amplifiers 1402 following the photodiodes 1401 which are part of the quad cell IR sensor (four photodiodes make up one quadcell). The signal causing this saturation can be removed by a “dc remover” feedback circuit. The circuit employed may be any of a large inductor, an inductor-capacitor tank circuit, or an active differential integrator. Compared to the active differential integrator, the inductor and inductor-capacitor tank circuits are expensive and may require additional modulation technology. The differential integrator 1403 compares the output of the transresistance amplifier 1402 to a bias voltage 1404 and integrates any difference that exists. This integrated signal is applied to the input of the transresistance amplifier 1402 through a resistor 1405 where it draws away the low frequency components of the output current of the photodiode. The resistor 1405 prevents the higher frequency desired signal components from being shunted away.

FIGS. 6A-6B are illustrative drawings of two example fields of view of the imager 116. An imager field of view comprises the image that is visible to the imager sensor, and therefore, may be recorded to and stored in a video format. Assume that the imager 116 employs a feature recognition process that recognizes a face, for example. Referring to the first example field of view 602 shown in FIG. 6A, the face is centered at location (X1, Y1) in the first field of view 602. Assume further that the objective of the motion tracking process is to center the recognized feature in the horizontal center of the field of view and one-third down from the top in the vertical direction. Referring to the second example field of view 604 shown in FIG. 6B, assume that as a result of operation of the fusion process 404 and the servo system 117, the imager 116 orientation is changed so that the face is centered at location (X2, Y2) in the second field of view, which is the desired location. As part of the process to change the orientation of the imager 116 to place the recognized feature at the desired location in the second example field of view, the imager 116 sends signals to the fusion process 404 that indicate the (X1, Y1) location, and in response, the fusion process 404 factors that information into the determination of object position. Thus, it will be appreciated that the imager 116 provides position information about particular visual feature of the tracked object 103 that is useful to refine determination of the position of the object 103.

Referring again to FIG. 6A, it can be seen that the remote device 102 is disposed upon the tracked object 103 at a position offset by a distance delta (A) from the feature that is to be recognized by the imager 116. The offset difference can be factored in to determining a desired change in orientation of the imager 116 based upon determinations of position of the remote device 116 and position of the recognized feature in the imager field of view. More specifically, the servo system may be calibrated to account for the offset distance when determining a desired orientation of the imager 116.

It will be noted that although tracking and event detection described herein involve physical objects in the physical world, position and event information collected through these tracking and tagging processes can be used to guide the motion of virtual objects in a virtual world. For example, position and event information gathered about movements and actions of a real person can be translated to virtual movements and virtual actions of a virtual animated person in a virtual world, such as in a video game scenario. In other words, an animated object (e.g., an animated character) is caused to minor or mimic the movements and actions of the real object (e.g., a person) that is tracked based upon position and event information gathered about that real object.

As an alternative embodiment, the servo system 117 does not provide mechanical tilt in base device. Rather, a tilt effect is achieved digitally in imager 116 by cropping an image from the captured image. Commands are issued from sensor fusion algorithm 404 for imager 116 to perform cropping operations. Desired aspect ratio of image is maintained and the image is cropped around tracked object 103.

Moreover, in some embodiments, base device memory 310 is preloaded with cinematic rules used to configure the base device processor 302 to dictate how the servo control system 117 should move the imager 116 relative to the tracked object. The base device servo control system 117 uses determined position data in combination with the cinematic rules in such a way that the tracked object is positioned correctly within the imager field of view. In some embodiments, the servo control system utilizes its own loop tracking algorithms known in the art, such as PID (Proportional Integrative Derivative) control loops to analyze the changes in position information and react to it.

Some example cinematic rules are as follows.

1. Let the tracked object move without moving orientation of the imager until the tracked object moves more than a prescribed distance away from the center of the field of view by the imager 116.

2. Use the accelerometer data to control the speed of the imager movement. For example, if the motion data indicates movement of the target object, but the IR signal is lost, then the servo 117 re-orients the position of the imager 116 in reaction to the motion data. On the other hand, if motion data indicates an acceleration of the tracked object, but the IR signal indicates that the object has not moved, then the servo/base system 117 past a threshold that results in unappealing video quality.

4. Avoid repetitive, opposing motions of a similar nature by storing determined position information indicative of past movements, comparing and limiting with some threshold.

In addition, in some embodiments, imager focus control (i.e. setting the focal point of an the imager lens (not shown) to match the distance to the tracked object) is adjusted based upon the position of the target determined according to the fusion process 404 to improve resulting image quality captured by the imager 116. This can also be done using known algorithms for the imager for focus in combination with the determined position information. Also, in some embodiments the determined position information is used to determine where auto-focus will be applied within the image frame.

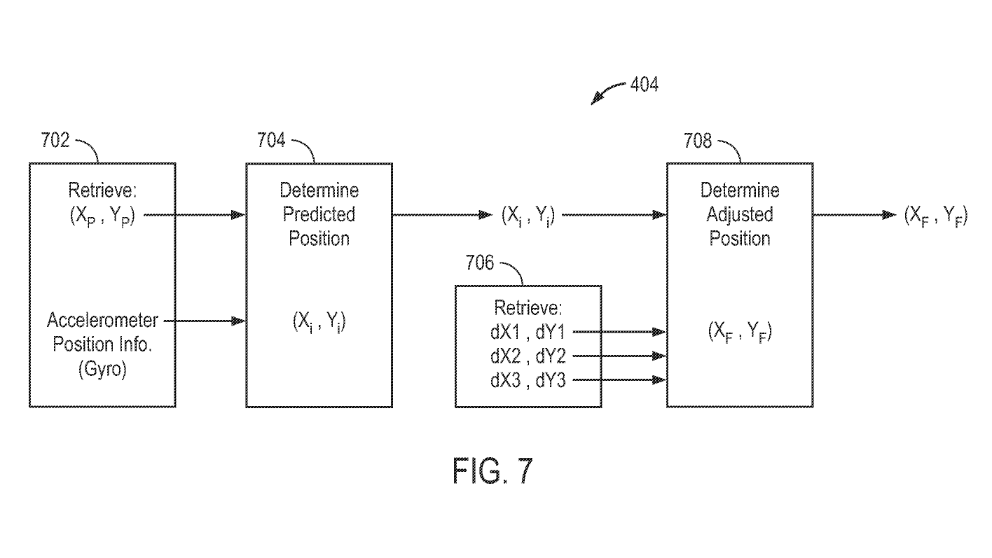

FIG. 7 is an illustrative flow diagram showing details of a sensor fusion process 404 to determine remote device position in accordance with some embodiments. Each module of the flow diagram represents configuration of the processor 302 to implement the act specified for the module. The process 404 runs at predetermined frequency of occurrence and updates the determined final position of the tracked object at each time increment or time stamp. During a predict phase, module 702 retrieved first new stored sensor data and a previously computed target position (Xp, Yp) from the storage device 310, and module 704 computes a predicted position (Xi, Yi) as a function of these values. During an adjust phase, module 706 retrieves second stored sensor data, and module 708 computes an adjusted updated final position (Xf, Yf) as a function of these second values and the predicted position (Xi, Yi). It will be appreciated that the sensor fusion process uses matrices of coefficients, in a manner that will be understood by persons skilled in the art and that have been predefined for the system as well as matrices of coefficients (such as covariance of the sensor data) that have been calculated at each timestamp as well as dynamic linear equations to derive the determined updated final position (Xf, Yf).

In general, the first data comprises sensor data that is more reliable, and therefore, better suited for use in the prediction phase. The second data comprises sensor data that is less reliable, and therefore, better suited for use in the adjustment phase. More specifically, in some embodiments, the first data comprises motion sensor position data such as the accelerometer and other physical sensor (e.g., gyroscope) position data. The second data includes observed azimuth and elevation displacement information from the remote device IR (dX1,dY1), base device reflective IR (dX2,dY2), and imager (PIS) object recognition (dX3,dY3) to refine the new predicted position into a more accurate adjusted position estimate, which is the determined position (Xf, Yf). Consider, for example, that during ordinary motion such as walking or sitting, the accelerometer sensor 112 provides information that is quite accurate as to changes in position. However, accelerometer based determinations are subject to drift over time. On the other hand, while IR signals (transmitted or reflected) can provide accurate position information, but these signals can be unreliable since they are subject to being temporarily blocked or out of view. Likewise, while image recognition can provide refined position information about recognized features of a tracked object, those features sometimes cannot be reliably discerned by the imager 116.

It will be understood that data from the same ‘time’ is used during both the predict phase and the adjust phase. More specifically, at each timestamp both phases are performed, first predict and then adjust. However, this is not necessary. If for some reason observed displacement information is not available, adjust may be skipped. Also if at a timestamp, one of the observed displacements is not available, the adjust phase can be performed with only the available data. Also, if accelerometer and other physical sensor data is not available at a timestamp, then adjust can be performed without the predict phase.

Moreover in alternative embodiments, alternative predict and adjust phases may be employed. For example, as one alternative, only remote device IR data are employed during the predict phase, and the other remote device data (motion and audio) are employed during the adjust phase. In yet another alternative, for example, only position information provided by the imager (e.g. position computed based upon captured video image data) is employed during the predict phase, and remote device IR data, acceleration data and audio data are used during the adjust phase.

Referring to FIG. 4, the servo control system 117 compares the newly computed target position (Xi, Yi) to the actual servo position and decides whether to change the orientation of the servo to better align the imager to the target object 103.

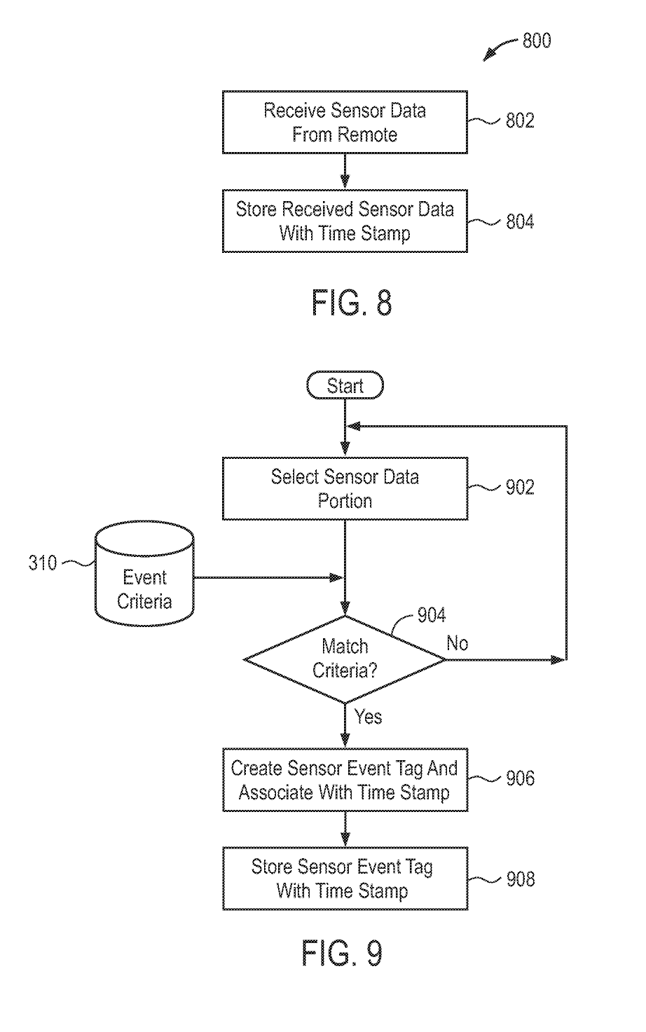

FIG. 8 is an illustrative flow diagram representing a process 800 in which the base device 104 receives sensor data from the remote device 102 and stores the received sensor data in memory device 310 in accordance with some embodiments. Each module of the flow diagram represents configuration of the base device processor 302 to implement the act specified for the module. The process of FIG. 8 is used for each of multiple kinds of sensor data. Module 802 receives sensor data such as, acceleration data, audio data, or gyroscope data, from the remote device 102 over the RF channel. It will be appreciated that each different kind of sensor data may be allocated a different time slot for transmission over the RF channel. Module 804 stores the received sensor data in the memory 310 in association with indicia, such as a time stamp, of the time at which the sensor data was received. More particularly, individual streams of sensor data, which may take the form of sequences of sensor sample data, are received by the based device 104 from the remote device 102 for each of multiple sensors, and sensor data from each of those streams is stored with indicia indicative of when the sensor data was received by the base device 104. As explained below, this time of receipt information is used to align the streams of sensor data based upon time of receipt with recorded video information and with other streams of stored sensor data and position data.

FIG. 9 is an illustrative flow diagram representing a process 900 to detect an event based upon received sensor information in accordance with some embodiments. Each module of the flow diagram represents configuration of a processor to implement the act specified for the module. The process of FIG. 9 is used for each of multiple kinds of sensor data. Module 902 selects a portion of the sensor data, such as a portion of the acceleration data, audio data, or gyroscope data, received during a given time interval, which may be associated with one or more given time stamps. The base device memory 310 stores event identification criteria used to evaluate the sensor data to identify the occurrence of prescribed events. Decision module 904 determines whether the selected sensor data corresponds to an event based upon the stored event identification criteria.

For example, for the acceleration sensor 112, the event identification criteria may include a library of acceleration profiles or prescribed thresholds that correspond to events involving motion such as throwing a ball or jumping or a deliberate control ‘gesture’. A gesture comprises a physical action such as moving one's hand back and forth while holding the remote device 102 or shaking the remote device or moving the device in a circular motion that indicates some event according to the acceleration profile. Continuing with the accelerometer example, the decision module 904 would compare a profile of received acceleration data with stored criteria profiles to determine whether an acceleration (or motion) event has occurred. Alternatively, for example, for the audio sensors 110, 124, the event identification criteria may include a library of sound profiles or prescribed thresholds that correspond to events involving sound such as the sound of laughter or the sound of a ball impact with a baseball bat. The decision module 904 would compare a profile of the audio data with stored criteria profiles to determine whether an audio event has occurred.

If decision module 904 determines that the selected sensor data does not correspond to a prescribed event according to the event identification criteria, then control flow returns to module 902. If decision module 904 determines that the selected portion of the sensor data does correspond to a prescribed event according to the event identification criteria, then module 906 creates an event tag to identify the detected event. Module 908 stores the event tag in the storage device in association with a time stamp of the time at which the selected portion of the acceleration data was received. More particularly, individual streams of sensor data, which may take the form of sequences of sensor sample data, are received by the base device 104 from the remote device 102 for each of multiple sensors, and sensor data from each of those streams is stored with time stamp information to indicate when each of respective data were received by the base device 104. As explained below, tags in conjunction with the time stamps are used to align events detected using sensors with recorded video information and with other streams of data.

With regard to the acceleration data, it will be appreciated that acceleration data is used both for tracking and for event detection. Ordinary motion such as walking or running can be tracked based upon acceleration data. Conversely, prescribed motions that correspond to an event such as a gesture or the swing of a baseball bat or a golf club can be identified based upon prescribed acceleration profiles or prescribed thresholds. Moreover, in some embodiments, a one or more motion sensor can be located physically separated from the remote device control electronics. For example, a first smaller sized accelerometer (not shown) could be mounted on a person's hand to more accurately follow hand movements during a golf swing. The first accelerometer could be electrically coupled to the remote device with a wire or through wireless communications, for example. In addition, a second accelerometer (not shown) could be located on a person's wrist in order to track larger body movements. The accelerator data for the two different accelerometers could communicate with the base device 104 during different time slots so as to distinguish their data.

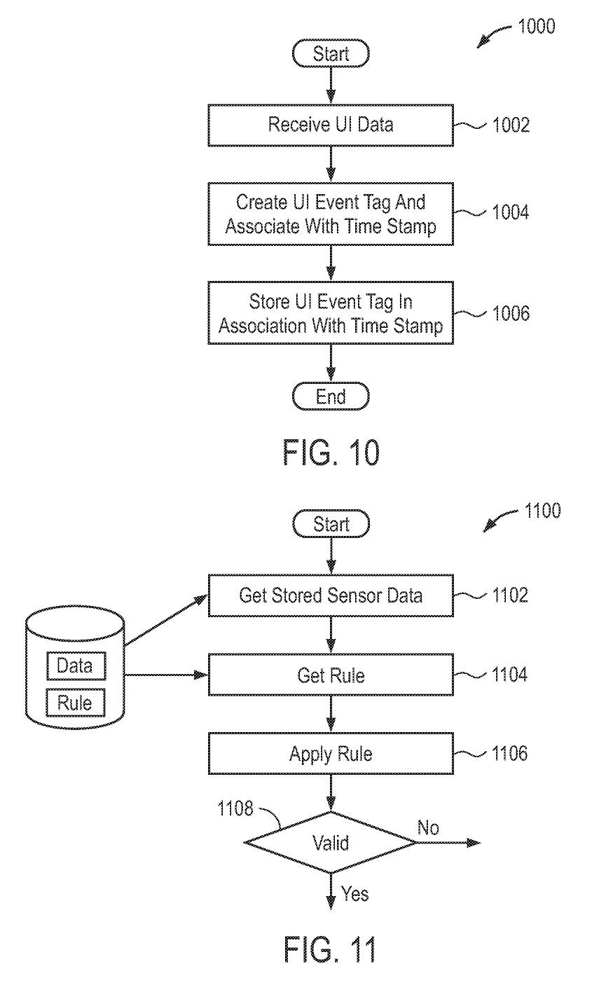

FIG. 10 is an illustrative flow diagram representing a process 1000 to detect an event based upon received user UI input information in accordance with some embodiments. Each module of the flow diagram represents configuration of a processor to implement the act specified for the module. Module 1002 receives data for a UI input to the remote device 102 which is transmitted from the remote device 102 to the base device 104 over the RF channel. Module 1004 creates a UI event tag that corresponds to the received user input information. The event tag includes information to identify the kind of event. Module 1006 stores the UI event tag in the memory 310 in association with time stamp to indicate the time at which the UI input was received. UI event tags in conjunction with their corresponding time stamps are used to align user UI events with recorded video information and with other streams of data.

In some embodiments, UI control signals can be transmitted from a second device (not shown) different from the device mounted on the tracked target. Thus tagging may result from operation of such a second remote device that transmits a UI signal to the base device 104. In that case, the flow described with reference to FIG. 10 would be the same except that the UI signal would be received from a different remote device.

FIG. 11 is an illustrative flow diagram representing a process 1100 to evaluate validity of a remote device position determined according to the sensor fusion process 404 of FIG. 7 in accordance with some embodiments. Each module of the flow diagram represents configuration of a processor to implement the act specified for the module. Module 1102 retrieves stored sensor data from the storage device 310. Module 1104 obtains from storage device 310 a rule that uses the retrieved sensor data to evaluate the validity of a position determined by the sensor fusion process. For example, if a tracked object's new position relative to the previous position implies that the object moved faster than a human being can move, the new determined position data is determined to be invalid. Module 1106 applies the rule to the retrieved sensor data. If decision module 1106 determines that the position is not valid it is discarded. If decision module 1106 determines that the position is valid it is used.

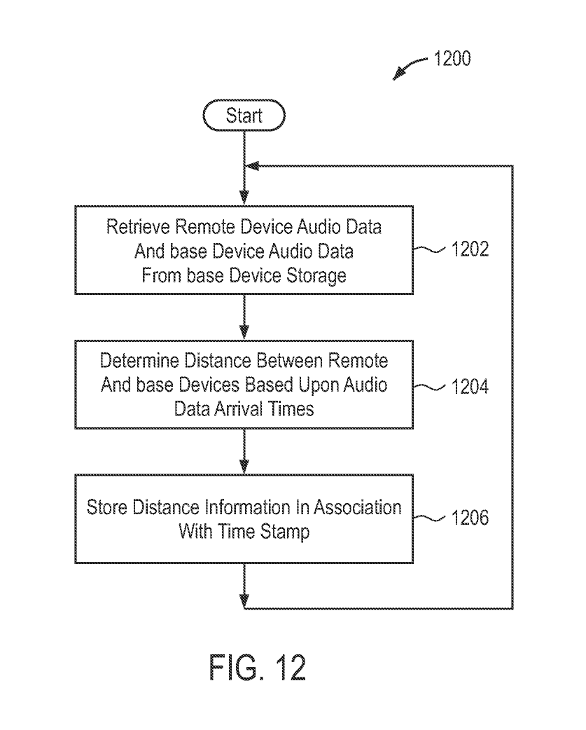

FIG. 12 is an illustrative flow diagram representing a process 1200 to determine distance between the remote device 102 and the base device 104 based upon audio data in accordance with some embodiments. As explained above with reference to FIG. 8, remote device sensor data is stored and time stamped by the base device 104. Thus, audio data produced by the remote device audio sensor 110 is stored with associated time stamp information in base device storage 104. Similarly, audio data produced by the base device audio sensor 124 is stored with associated time stamp information in base device storage. Module 802 selects and retrieves from memory 310 the stored remote device audio data and base device audio data for a next prescribed time slot. Module 804 determines distance between the remote and base devices during the selected time slot based upon difference in arrival times of identical sounds represented by the remote and base device audio data during the time slot. Module 806 stores the determined distance in a storage device in association with a time stamp to indicate the time at which the remote and base devices were at the determined distance apart. Control then flows to module 802, and audio data for a next time slot is selected.

The distance measurement computed according to the process 1200 of FIG. 12 also is provided to the sensor fusion process 404 of FIG. 7 to contribute to the tracking of the tracked object 103. Thus, the audio data are used both for tracking and as explained with reference to process 900 of FIG. 9, for event detection.

Two alternate methods for determining distance between the remote device 102 and the base device 104 involve RF signal strength measurement and IR signal strength measurement, respectively. In the RF signal strength alternative, baseline RF strength is measured during initial remote to base synchronization and connection. As RF strength increases or decreases, an algorithm is applied to the signal that calculates estimated distance changes. Distance changes are stored in memory 310 for tracking, tagging and editing. In the IR signal strength alternative, baseline IR strength is similarly measured during initial optical acquisition. As IR strength increases or decreases, an algorithm is applied to the signal that calculates estimated distance changes. Distance changes are stored in memory 310 for tracking, tagging and editing.

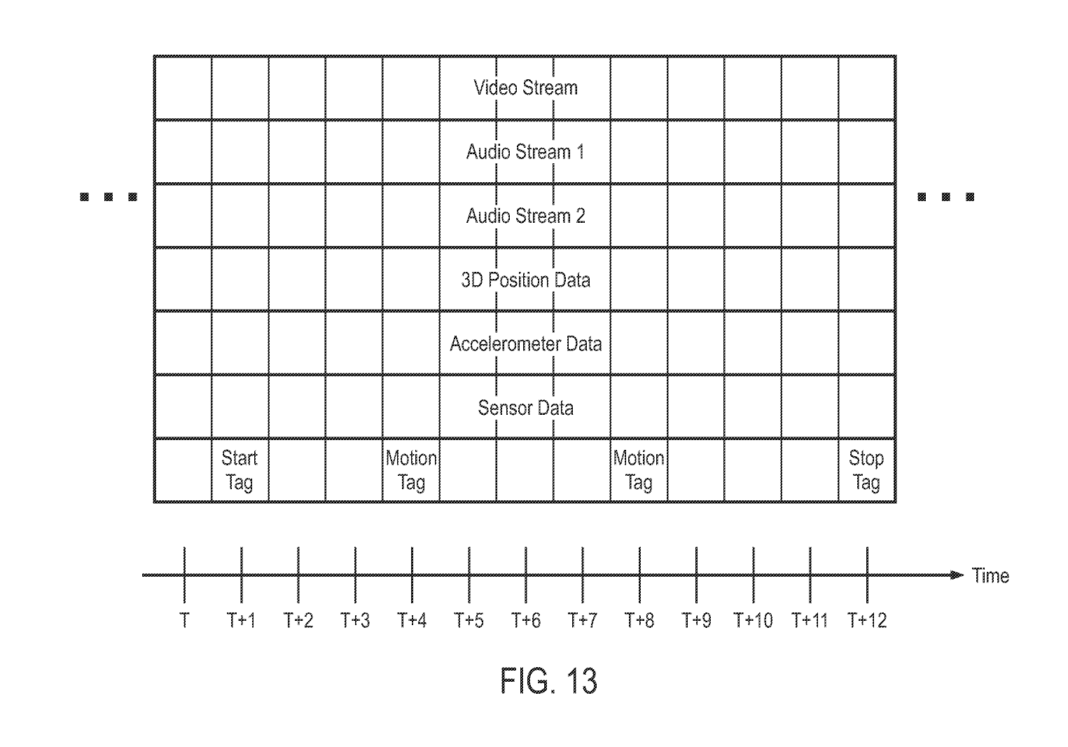

FIG. 13 is an illustrative drawing of a merged data structure encoded in the storage device 310 of the base device 104 in accordance with some embodiments. The data structure includes a video stream recorded using the imager 116 and first and second audio data streams generated by the remote device microphone 110 and the base device microphone 124, respectively. The data structure includes a 3-dimensional position data stream determined using the sensor fusion process 404. The data structure also includes an accelerometer data stream generated by the remote device accelerometer 112. The data structure includes another sensor data stream such as UI data generated through user UI control inputs. Each data stream is aligned with time stamp information (T, T+1, . . . T+12) stored in the storage device 310 as part of the data structure. In addition, the data structure includes event tags that are stored in the storage device 310 as part of the data structure and that are associated with time stamps. The time stamps serve to align the event information with corresponding portions of the data streams that generated the event tags.

Providing multiple steams of sensor data and position data augmented by time stamps and event tags provides a rich collection of information for use in selecting and editing the video data stream. For example, if a user wishes to search for a portion of the video data stream that corresponds to the sound of a bat hitting a ball, then the user could look at video clips around event tags that indicate the occurrence of that sound. Alternatively, if the user wants to look at portions of video that correspond to the swinging of a bat whether or not the bat connects with the ball, then the user could look at video clips around event tags that indicate the occurrence of a motion like the swinging of a bat. Other kinds of data also could be included in the feed. For example, the remote device 102 could be equipped with a GPS unit, and could report GPS coordinates to the base device 104 over the RF channel. In that case, one of the sensor streams could provide GPS coordinates that are time aligned with the video stream. Tags could be generated based upon the occurrence of select GPS coordinates and the video stream could be searched based upon the GPS tags.

In alternate embodiment in which a gyroscope is used, or in the case that each IR LED on the remote is running at a different time basis, the orientation of the remote should be known with respect to the base. In this case, feedback is sent over the RF communications to turn off the remote device IR LEDs facing the wrong way to save power.

In an alternative embodiment in which multiple remotes are employed, each remote device (‘remote’) is assigned a unique identifier code, and the base device 104 distinguishes between the multiple remotes on the basis of those unique identifier codes. Once each remote is identified by the base, independent time basis (each remote having a specific time slice) for communications are established so they do not conflict. The different remotes can be distinguished by the quad cell imager by selecting time basis for reading the IR signals. Alternatively, via RF communication, a remote not being tracked can be shut off until a command to be tracked is observed. This is advantageous for saving battery. Each remote can send independent audio and accelerometer data using RF communications link that can be used for the sensor fusion algorithm as specified above. The remainder of video and data capture proceeds similar to the single remote case.

There are a variety of approaches to informing the base device which remote device to track. One approach is to use the UI on the remotes to signal the base device 104. For example a UI switch on a remote is turned on to indicate the remote to track. A gesture measured by the remote (“throwing” control back and forth in a simulated, or real fashion in the example of throwing a ball), measured, for example, as a peak acceleration value that exceeds a stored threshold by the accelerometer to demonstrate which remote to follow.

Voice activation can be used to determine which remote should be tracked by the imager 116. The remote microphone records the user's voice and sends it over RF communications to the base. An envelope detector (amplitude peak detector) is used to determine the presence of sound. When a sound is detected by the remote, the base device 104 selects that remote to track. When speaker stops, the corresponding remote is tracked until the second user/speaker uses his voice. At this point, base device 104 switches to the new remote to track. In this way, the imager shuttles back and forth between speakers in conversations.

An alternate method to select the remote to track is to use a microphone driven data packet that turns on corresponding remote's IR LEDs for a specified period of time, at the end of which the signal stops and the system holds. Tracking resumes when new IR signal is received. An additional alternative method is to compare time of flight difference between the different remotes' audio streams. The remote which has the least delay in the audio stream is tracked by the base.

More complex algorithms which take into account 3D position data of multiple remotes. Examples are averaging algorithm (find average position of all available remotes and point imager at the average position) or time division algorithm (point imager at each available remote for a certain period of time).

Another approach to the use of two remotes in the system is that of having different roles (for example, distinguishing “target” versus “director”). A target remote is defined as the remote to be tracked by the imaging system as defined before. A director remote is identified as such manually by the users as described above through a remote interface provided, or the second user can simply be outside of the usable range of the quad cell IR sensor. The director remote is not used for object tracking. A remote designated as a dedicated director remote by selecting unique RF identifiers or optical frequencies. The base device receives commands from the director remote through RF communications and uses that for imaging control and other data input needs for follow-up editing.

The foregoing description and drawings of embodiments in accordance with the present invention are merely illustrative of the principles of the invention. Therefore, it will be understood that various modifications can be made to the embodiments by those skilled in the art without departing from the spirit and scope of the invention, which is defined in the appended claims.

What is claimed is:

1. A method to track an object comprising:
directing a video imager to perform image recognition to recognize a feature of the object within an imager field of view and to determine a position of the feature within the field of view;
transmitting an infrared (IR) signal by an IR transmitter disposed upon the object;
using an IR sensor to determine a position of the infrared (IR) transmitter; and
automatically adjusting orientation of the imager based upon the position of the recognized feature within the field of view and the determined position of the IR transmitter to follow movement of the object.

2. The method of claim 1,
wherein automatically adjusting includes adjusting as a function of an offset between a location of a portion of the object that includes the recognized feature and a location on a portion of the object upon which the IR transmitter is disposed.

3. The method of claim 1,
wherein the IR sensor is disposed adjacent to the imager.

4. The method of claim 1,
wherein the video imager is mounted upon a servo system; and
wherein automatically adjusting orientation of the imager includes using the servo system to adjust the orientation of the imager.

5. The method of claim 1,
wherein automatically adjusting orientation of the imager includes cropping an image within the imager field of view.

6. The method of claim 1,
wherein automatically adjusting orientation of the imager includes configuring a processor to implement a sensor fusion process to determine an updated final position of the object as a function of the position of the recognized feature within the field of view and the determined position of the IR transmitter.

7. The method of claim 1,
wherein the video imager is mounted upon a servo system;
wherein automatically adjusting orientation of the imager includes configuring a processor to implement a sensor fusion process to determine an updated final position of the object as a function of the position of the recognized feature within the field of view and the determined position of the IR transmitter; and
wherein automatically adjusting orientation of the imager further includes using the servo system to adjust the orientation of the imager based upon the determined final position of the object.

8. The method of claim 1
using first sensor data generated by a motion sensor to detect position of the object;
wherein automatically adjusting orientation of the imager includes configuring a processor to implement a sensor fusion process to determine an updated final position of the object as a function of the position of the recognized feature within the field of view and the determined position of the IR transmitter and the first sensor data.

9. The method of claim 8,
wherein the first sensor is mounted upon the object.

10. The method of claim 1
using second sensor data generated by an audio sensor to detect position of the object;
wherein automatically adjusting orientation of the imager includes configuring a processor to implement a sensor fusion process to determine an updated final position of the object as a function of the position of the recognized feature within the field of view and the determined position of the IR transmitter and the second sensor data.

11. The method of claim 1
using first sensor data generated by a motion sensor to detect position of the object;
wherein automatically adjusting orientation of the imager includes configuring a processor to implement a sensor fusion process to determine an updated final position of the object as a function of the position of the recognized feature within the field of view and the determined position of the IR transmitter and the first sensor data and the first sensor data and the second sensor data.

12. A system comprising:
a video imager configured to perform image recognition to recognize a feature of an object within an imager field of view and to determine a position of the feature within the field of view;
an IR transmitter disposed upon the object to transmit an infrared (IR) signal;
an IR sensor disposed to determine a position of the infrared (IR) transmitter; and
means for determining a position as a function of a recognized feature within the field of view and a determined position of the IR transmitter.

13. The system of claim 12 further including:
a servo system configured to receive the determined position information and to change orientation of the imager to follow the object in response to the received position information.

14. The system of claim 12,
wherein the means for determining includes a photocell.

15. The system of claim 12,
wherein the means for determining includes a processor configured to implement a sensor fusion process.

16. A method to track an object comprising:
directing a video imager to capture video images of an object within an imager field of view;
transmitting a first infrared (IR) signal by a first IR transmitter disposed upon the object to transmit the first IR signal in a first direction away from the object;
transmitting a second IR signal by a second IR transmitter disposed to transmit the second IR signal in a second direction toward the object so that the second IR signal reflects off the object in a third direction away from the object;
using an IR sensor to determine a position of the object based upon the first IR signal when the IR sensor is in a path of the first direction and to determine a position of the object based upon the second IR signal when the IR sensor is in a path of a path of the third direction; and
automatically adjusting orientation of the imager to follow the object in the field of view based upon the determined position of the object.

17. The method of claim 16,
wherein the second IR transmitter disposed adjacent to the imager.

18. The method of claim 16,
wherein the IR sensor is disposed adjacent to the imager; and
wherein the second IR transmitter disposed adjacent to the imager.

19. The method of claim 16 further including:
wherein transmitting the first IR signal includes transmitting the first IR signal during first time slots; and
wherein transmitting the second IR signal includes transmitting the second IR signal during second time slots.

20. The method of claim 16 further including:
using the IR sensor to determine a position of the object based upon both the first IR signal and the second IR signal when the IR sensor is in both the path of the first direction and is in a path of a path of the third direction.

21. The method of claim 16,
wherein determining a position of the object includes configuring a processor to implement a sensor fusion process to determine an updated final position of the object as a function the determined position of the object based upon the first IR signal and the determined position of the object based upon the second IR signal.

22. The method of claim 16 further including:
using first sensor data generated by a motion sensor to detect position of the object;
wherein determining a position of the object includes configuring a processor to implement a sensor fusion process to determine an updated final position of the object as a function the determined position of the object based upon the first IR signal and the determined position of the object based upon the second IR signal and the first sensor data.

23. The method of claim 16
using second sensor data generated by an audio sensor to detect position of the object;
wherein determining a position of the object includes configuring a processor to implement a sensor fusion process to determine an updated final position of the object as a function the determined position of the object based upon the first IR signal and the determined position of the object based upon the second IR signal and the second sensor data.

24. The method of claim 16 further including:
automatically adjusting orientation of the imager based upon the determined position of the object.

25. A system comprising:
a video imager;
a first IR transmitter disposed upon the object to transmit a first IR signal in a first direction away from the object;
a second IR transmitter disposed to transmit a second IR signal in a second direction toward the object so that the second IR signal reflects off the object in a third direction away from the object;
an IR sensor disposed to determine a position of the object based upon the first IR signal when the IR sensor is in a path of the first direction and to determine a position of the object based upon the second IR signal when the IR sensor is in a path of a path of the third direction; and
means for automatically adjusting orientation of the imager to follow the object in the field of view based upon the determined position of the object.

26. The system of claim 25,
wherein the means for automatically adjusting includes a servo system configured to receive the determined position and to change orientation of the imager to follow the object in response to the received position information.

27. The system of claim 25,
wherein the means for automatically adjusting includes the imager configured to crop an image within the imager field of view.

28. A method to tag video data with information about content of the video data comprising:
directing a video imager to capture video images of an object;
using first sensor data generated by a sensor to detect position of the object;
automatically adjusting orientation of the imager as a function of the detected position of the object so as to follow movement of the object;
using second sensor data generated by a sensor to identify an event; and
storing the video data in a computer readable storage device in association with time stamps to indicate the relative time of occurrence of different portions of the video data and in association with a tag that identifies the detected event and that is associated with a time stamp.

29. The method of claim 28,
wherein the first sensor is disposed upon the object.

30. The method of claim 28,
wherein the second sensor is disposed on the object.

31. The method of claim 28,
wherein the first data sensor data and the second sensor data are generated by the same sensor.

32. The method of claim 28,
wherein the first data sensor data and the second sensor data are generated by the same motion sensor.

33. The method of claim 32,
wherein the motion sensor includes an accelerometer.

34. The method of claim 32,
wherein the motion sensor includes an gyroscope.

35. The method of claim 28,
wherein the first data sensor data and the second sensor data are generated by the same audio sensor.

36. The method of claim 28,
wherein the first data sensor data and the second sensor data are generated by different sensors.

37. The method of claim 36,
wherein the first sensor includes a first accelerometer; and
wherein the second sensor includes a second accelerometer.

38. The method of claim 36,
wherein the first sensor includes an accelerometer; and
wherein the second sensor includes an audio sensor.

39. A system comprising:
a video imager;
a first sensor;
a second sensor;
means for automatically adjusting orientation of the imager to follow an object within an imager field of view based upon object position information collected by the first sensor; and
a machine readable storage device encoded with storing video data captured by the video imager in association with time stamps to indicate the relative time of occurrence of different portions of the video data and in association with a tag that identifies an event detected by the second sensor wherein the tag is associated with a time stamp.

40. The system of claim 39,
wherein the first and second sensors comprise the same.

41. The system of claim 39,
wherein the first and second sensors comprise different sensor devices.

42. The system of claim 39,
wherein the means for automatically adjusting includes a servo system configured to receive the determined position and to change orientation of the imager to follow the object in response to the received position information.

43. The system of claim 39,
wherein the means for automatically adjusting includes the imager configured to crop an image within the imager field of view.
